(19) United States
(12) Patent Application Publication
(10) Pub. No.: US 2026/0303962 A1
(43) Pub. Date: Oct. 1, 2026

(54) CONTROL APPARATUS, CONTROL METHOD, AND STORAGE MEDIUM

(71) Applicant: CANON KABUSHIKI KAISHA, Tokyo (JP)

(72) Inventor: AKIHISA TERAMI, Shiga (JP)

(21) Appl. No.: 19/569,218

(22) Filed: Mar. 17, 2026

(30) Foreign Application Priority Data
Mar. 31, 2025 (JP) 2025-059913

(51) Int. Cl. H04N 23/60; G06T 7/73; H04N 23/611

(52) U.S. Cl. CPC H04N 23/64; G06T 7/74; G06T 2207/20081; G06T 2207/20101; G06T 2207/30196; G06T 2207/30244; H04N 23/611

(57) ABSTRACT

A control apparatus determines at least two first feature points as target feature points from among a plurality of first feature points extracted from a first object included in a first image obtained by first capturing, detects second feature points corresponding to the target feature points as feature points of interest from among a plurality of second feature points extracted from a second object included in a second image obtained by second capturing, obtains a correction amount for at least one of a position and direction of an image capturing device in third capturing of the second object based on positions of the target feature points and positions of the feature points of interest corresponding to the target feature points, and outputs the correction amount.

### BACKGROUND

### Field of the Technology

The present disclosure relates to a technology for assisting capturing.

### Description of the Related Art

There is a technology that allows a photographer to more easily capture an image with a desired composition by estimating the orientation or skeleton of the capturing target such as a natural person (hereinafter referred to as “subject”) before the capturing. Published Japanese Translation of PCT International Application No. 2017-532922 (hereinafter referred to as “Patent Document 1”) discloses a technology in which a voice message that prompts a natural person who is a subject to change the orientation is output in a case where the orientation of a natural person set in advance and the orientation of the subject natural person do not coincide with each other.

### SUMMARY

A problem with Patent Document 1 is that, in a case where each of a plurality of natural persons with different physiques is a subject, it may not be possible to capture each of them with the same composition even if their orientations are the same.

A control apparatus according to the present disclosure: determines at least two first feature points as target feature points from among a plurality of first feature points extracted from a first object included in a first image obtained by first capturing; detects second feature points corresponding to the target feature points as feature points of interest from among a plurality of second feature points extracted from a second object included in a second image obtained by second capturing; obtains a correction amount for at least one of a position and direction of an image capturing device in third capturing of the second object based on positions of the target feature points and positions of the feature points of interest corresponding to the target feature points; and outputs the correction amount.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram for describing an example of a use case according to a first embodiment;

FIG. 2 is a block diagram illustrating an example of a hardware configuration of an image capturing apparatus according to the first embodiment;

FIG. 3 is a block diagram illustrating an example of a functional configuration of the image capturing apparatus according to the first embodiment;

FIGS. 4A to 4D are diagrams for describing an example of a method of training an orientation estimation deep learning (DL) model according to the first embodiment;

FIG. 5 is a diagram illustrating an example of a feature point selection screen according to the first embodiment;

FIG. 6 is a diagram for describing an example of a method of detecting feature points of interest according to the first embodiment;

FIG. 7 is a flowchart illustrating an example of the flow of a process by the image capturing apparatus according to the first embodiment;

FIG. 8 is a flowchart illustrating an example of the flow of a process by the image capturing apparatus according to the first embodiment;

FIG. 9 is a flowchart illustrating an example of the flow of a process of obtaining an amount of movement of the image capturing apparatus according to the first embodiment;

FIG. 10 is a diagram for describing an example of a method of obtaining an amount of movement of the image capturing apparatus according to the first embodiment;

FIG. 11 is a diagram illustrating an example of a display screen for the amount of movement of the image capturing apparatus according to the first embodiment;

FIG. 12 is a diagram illustrating an example of a display screen for the amount of movement of the image capturing apparatus according to the first embodiment; and

FIG. 13 is a diagram for describing an example of a use case according to a modification of the first embodiment.

### DESCRIPTION OF THE EMBODIMENTS

In a case of individually and sequentially capturing each of a plurality of natural persons as a subject, capturing each natural person in the same orientation with the same composition requires the positions of each natural person's body parts to coincide within the angle of view even if the natural persons have different physiques. Such capturing may be implemented by making the positions of at least two body parts of the different natural persons coincide with each other within the angle of view.

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

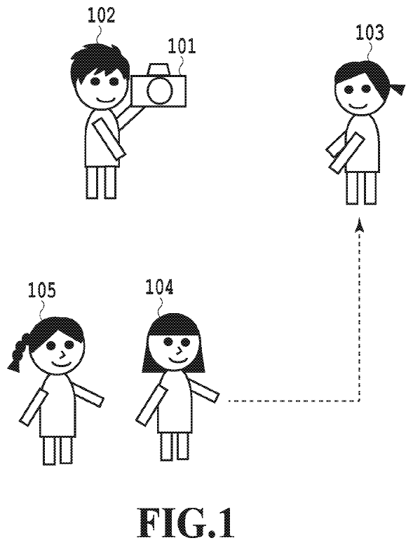

In the present embodiment, an aspect in a case of individually and sequentially capturing each of a plurality of natural persons as a subject in the same orientation with the same composition will be described as an example. FIG. 1 is a diagram for describing an example of a use case according to the first embodiment. A photographer 102 operates an image capturing apparatus 101 to individually and sequentially capture natural persons 103 to 105. The image capturing apparatus 101 is an apparatus having a function to capture still images, such as a digital still camera or a smartphone. In the present embodiment, a case where the photographer 102 individually and sequentially captures players in a sports team, students at a school, or the like will be described as an example. Also, in the present embodiment, a case where the photographer 102 attempts to capture each of the natural persons 103 to 105 such that each of the natural persons 103 to 105 are in the same orientation and the representation of each of the natural persons 103 to 105 has the same composition in the still image will be described as an example.

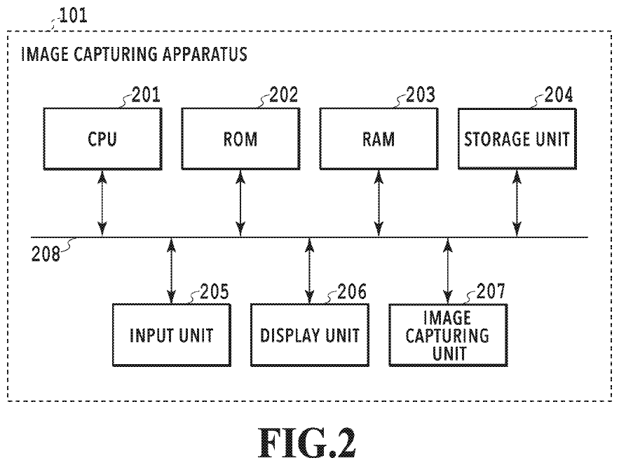

FIG. 2 is a block diagram illustrating an example of a hardware configuration of the image capturing apparatus 101 according to the first embodiment. The image capturing apparatus 101 includes a central processing unit (CPU) 201, a read-only memory (ROM) 202, a random-access memory (RAM) 203, a storage unit 204, an input unit 205, a display unit 206, and an image capturing unit 207 as its hardware configuration. The elements included in the image capturing apparatus 101 as its hardware configuration are communicably connected to one another through a bus 208.

The CPU 201 is a control unit including at least one processor or a circuit and controls the whole image capturing apparatus 101 by executing programs loaded to the RAM 203, for example. The ROM 202 is a memory storing a boot program to be executed by the CPU 201 in a case of starting the image capturing apparatus 101, computer programs for executing processes, data to be used by the computer programs, and the like. The RAM 203 is a work memory to temporarily store programs and data in order for the CPU 201 to perform arithmetic operations, and various programs and data are loaded to the RAM 203 by the CPU 201.

The storage unit 204 is a storage medium configured with a Secure Digital (SD) card or a built-in flash memory, and stores data of captured images obtained by capturing and the like. The input unit 205 is configured with a touch panel, buttons, or the like and accepts input of operations from the photographer 102. The display unit 206 is a display device configured with a liquid crystal monitor, an electronic viewfinder, or the like and displays images obtained by capturing, guides, a live view, or various graphical user interfaces (GUIs). The image capturing unit 207 is an image sensor configured with an element that converts an optical image into an electrical signal, such as a charge coupled device (CCD) or a complementary metal oxide semiconductor (CMOS) sensor. Also, the image capturing unit 207 includes a plurality of microlenses on its sensor surface, and is capable of measuring the distance to a subject based on a phase difference.

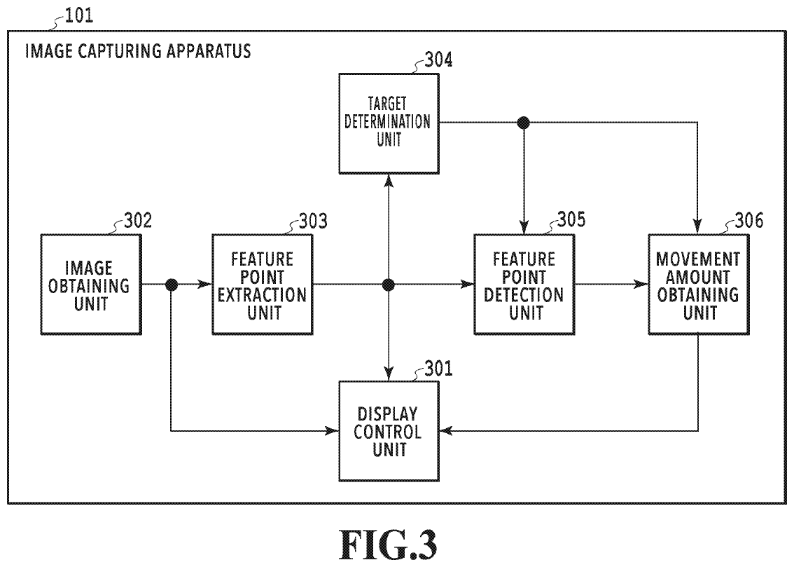

FIG. 3 is a block diagram illustrating an example of a functional configuration of the image capturing apparatus 101 according to the first embodiment. The image capturing apparatus 101 includes a display control unit 301, an image obtaining unit 302, a feature point extraction unit 303, a target determination unit 304, a feature point detection unit 305, and a movement amount obtaining unit 306 as its functional configuration. Each element included in the image capturing apparatus 101 as its functional configuration is implemented by the CPU 201 loading a computer program stored in the ROM 202 or the like to the RAM 203 and executing it.

The display control unit 301 performs a display control process for displaying an image to be displayed on the display unit 206. Details of the process by the display control unit 301 will be described later. The image obtaining unit 302 obtains frames forming a preview image based on an electrical signal corresponding to the optical image formed on the image capturing unit 207. Also, in a case where the photographer 102 presses the shutter button, the image obtaining unit 302 obtains the image captured as a still image based on the electrical signal corresponding to the optical image formed on the image capturing unit 207. Data of the frames forming a preview image and the captured image obtained by the image obtaining unit 302 is stored in the RAM 203, and the preview image and the captured image are displayed as displayed images on the display unit 206 by the display control unit 301.

The feature point extraction unit 303 extracts feature points on the natural persons 103 to 105 included as representations in the frames forming a preview image and the captured image obtained by the image obtaining unit 302. For example, the feature point extraction unit 303 extracts feature points on the natural persons 103 to 105 as follows. Specifically, first, the feature point extraction unit 303 inputs the frames forming a preview image and the captured image into a learned orientation estimation DL model to thereby estimate the orientations of the natural persons 103 to 105 included as representations in the frames or the captured image. Then, using the result of this estimation, the feature point extraction unit 303 extracts feature points in the representations of the natural persons 103 to 105. Here, the feature points are points corresponding to representative body parts of the natural persons 103 to 105, such as the shoulders or the tops of the heads of the natural persons 103 to 105.

Information on the feature points extracted by the feature point extraction unit 303 (hereinafter referred to as “feature point information”) is stored in the RAM 203. The feature point information is information in which information on coordinates indicating the positions of the feature points and information indicating body parts corresponding to the feature points are associated with each other. The coordinates indicating the positions of the feature points may be, for example, expressed by two-dimensional coordinates indicating positions in the frames forming a preview image and the captured image or expressed by three-dimensional coordinates using a camera coordinate system or the like. In the following, the present embodiment will be described on the assumption that the coordinates indicating the positions of the feature points are expressed by three-dimensional coordinates using a camera coordinate system. Also, the information indicating the body parts is expressed by character strings indicating the body parts, such as “HEAD” or “RIGHT-HAND,” for example.

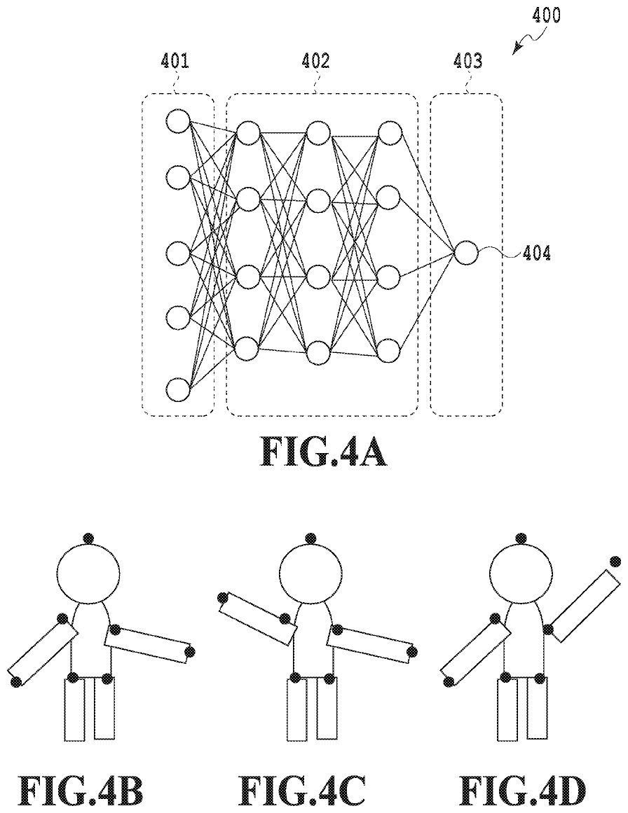

FIGS. 4A to 4D are diagrams for describing an example of a method of training an orientation estimation DL model according to the first embodiment. FIG. 4A illustrates an example of a configuration of an orientation estimation DL model 400. The orientation estimation DL model includes an input layer 401, an intermediate layer 402, and an output layer 403, and each layer includes one or more nodes 404. FIGS. 4B to 4D illustrate an example of training data. The orientation estimation DL model 400 is trained by inputting information on the skeletons of various natural persons as illustrated as an example in FIGS. 4B to 4D as training data into the orientation estimation DL model 400.

In a case of capturing the first natural person 103, the feature point extraction unit 303 extracts feature points from a captured image obtained by the image obtaining unit 302 after the photographer 102 presses the shutter button. Also, in a case of capturing the second or subsequent natural person 104 or 105, the feature point extraction unit 303 extracts feature points from frames forming a preview image obtained by the image obtaining unit 302 before the photographer 102 presses the shutter button.

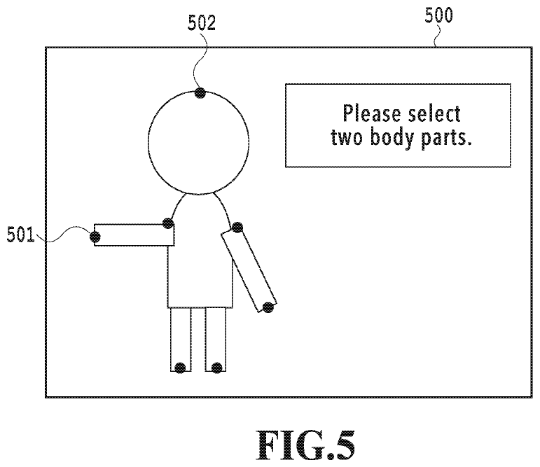

FIG. 5 is a diagram illustrating an example of a feature point selection screen 500 displayed on the display unit 206 according to the first embodiment. As illustrated in FIG. 5, in a case where the first natural person 103 is captured, the display control unit 301 superimposes the feature points on the natural person 103 and a message prompting the photographer 102 to designate body parts on the captured image obtained by the image obtaining unit 302 and displays them on the display unit 206. In FIG. 5, the points illustrated with the black dots represent the feature points on the natural person 103.

The target determination unit 304 determines feature points corresponding to at least two body parts of the natural person 103, who is the first subject, to be feature points of interest (hereinafter referred to as “target feature point”). For example, on the selection screen 500 displayed on the display unit 206, the photographer 102 designates at least two body parts of the natural person 103 included as a representation in the selection screen 500 by operating the touch panel, buttons, or the like. Based on an input signal corresponding to the operation by the photographer 102, the target determination unit 304 determines the at least two designated body parts of the natural person 103 to be target feature points. Information on each target feature point determined by the target determination unit 304 is stored as target feature point information in the storage unit 204 or the like. Here, the target feature point information is feature point information corresponding to the target feature point. That is, the feature point information corresponding to the target feature point determined by the target determination unit 304 is stored as target feature point information in the storage unit 204 or the like. In the following, a case where a feature point 501 corresponding to the right hand of the natural person 103 and a feature point 502 corresponding to the top of the head of the natural person 103 are determined to be target feature points will be described as an example.

In a case of capturing the second or subsequent natural person 104 or 105, the feature point detection unit 305 detects feature points corresponding to the target feature points from among the feature points extracted from the frames forming a preview image by the feature point extraction unit 303. Specifically, based on the target feature point information stored in the storage unit 204 or the like, the feature point detection unit 305 detects the feature points matching the body parts of the target corresponding respectively to the feature points 501 and 502 from among the feature points extracted from the preview image by the feature point extraction unit 303. The feature point information corresponding to the feature points detected by the feature point detection unit 305 is stored in the RAM 203 as feature point information on feature points to be updated, and will be used in a process of obtaining an amount of movement of the image capturing apparatus 101 by the movement amount obtaining unit 306 to be described later. In the following description, the feature points to be updated will be referred to as “feature points of interest” and the feature point information on the feature points of interest will be referred to as “feature point of interest information.”

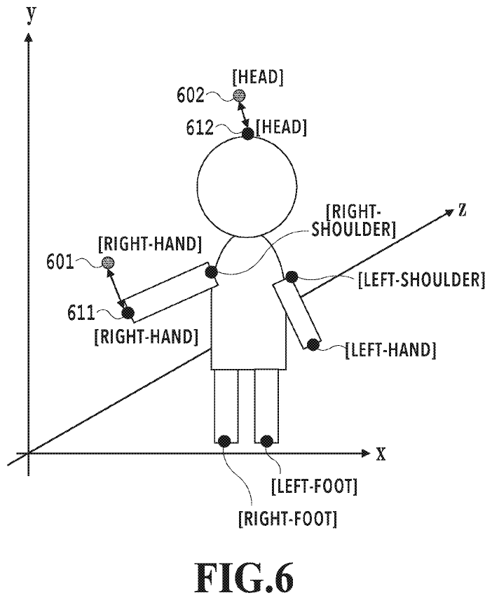

FIG. 6 is diagram for describing an example of a method by which the feature point detection unit 305 detects the feature points of interest according to the first embodiment. The points illustrated with the gray dots represent two target feature points 601 and 602 represented by target feature point information stored in the storage unit 204 or the like. Also, the points illustrated with the black dots represent feature points extracted from frames forming a preview image by the feature point extraction unit 303. The character strings presented in association respectively with the target feature points 601 and 602 and the plurality of feature points indicate the names of the body parts corresponding respectively to the target feature points 601 and 602 and the plurality of feature points. The feature point detection unit 305 detects feature points 611 and 612 corresponding to the same body parts as the target feature points 601 and 602 from among the plurality of feature points extracted from the frames forming a preview image by the feature point extraction unit 303.

The movement amount obtaining unit 306 obtains an amount of movement of the image capturing apparatus 101 required for the positions of the feature points of interest to reach the positions of the target feature points (hereinafter referred to simply as “the amount of movement of the image capturing apparatus 101”). A method of obtaining the amount of movement of the image capturing apparatus 101 will be described later. The display control unit 301, for example, superimposes the amount of movement of the image capturing apparatus 101 obtained by the movement amount obtaining unit 306 on the preview image and displays them on the display unit 206. A method of displaying the amount of movement of the image capturing apparatus 101 will be described later.

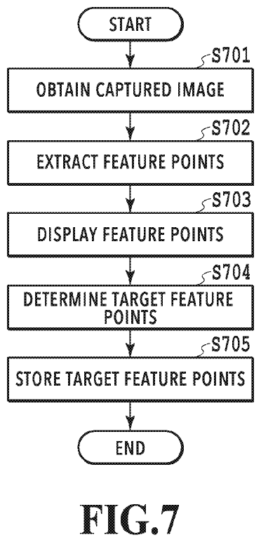

FIG. 7 is a flowchart illustrating an example of the flow of a process by the image capturing apparatus 101 according to the first embodiment. Specifically, the flowchart illustrated in FIG. 7 illustrates an example of the flow of a process from capturing of the first natural person 103 up to determination of the target feature points. Note that each step in the flowchart will be described below using a sign starting with “S”. Also, the process of each step described below is implemented by the CPU 201 loading a program stored in the ROM 202 or the like to the RAM 203 and executing them.

First, in S701, the image obtaining unit 302 obtains a captured image obtained by capturing a still image of the first natural person 103. Then, in S702, using the captured image obtained in S701, the feature point extraction unit 303 estimates the orientation of the natural person 103 included as a representation in the captured image to extract feature points corresponding to body parts of the natural person 103. Then, in S703, the display control unit 301 superimposes the feature points extracted in S702 on the captured image obtained in S701 and displays them on the display unit 206. Then, in S704, from among the plurality of feature points extracted in S702, the target determination unit 304 determines two feature points designated by the photographer 102 to be target feature points. Then, in S705, the target determination unit 304 stores information on the feature points determined in S704 (feature point information) as target feature point information in the storage unit 204. After S705, the image capturing apparatus 101 terminates the process of the flowchart illustrated in FIG. 7.

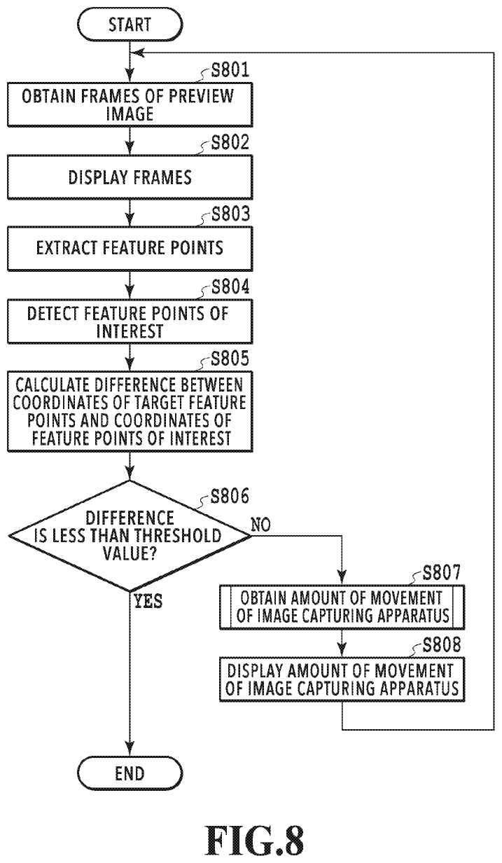

FIG. 8 is a flowchart illustrating an example of the flow of a process by the image capturing apparatus 101 according to the first embodiment. Specifically, the flowchart illustrated in FIG. 8 is executed after the flowchart illustrated in FIG. 7 is executed, and represents an example of the flow of a process up to determination of the composition in a case of capturing the second or subsequent natural person 104 or 105. Note that the flowchart illustrated in FIG. 8 illustrates an example of the flow of a process in a case where the natural person 104 or 105 does not move and the photographer 102 moves the image capturing apparatus 101 during a composition adjustment preceding the capturing of the second or subsequent natural person 104 or 105.

First, in S801, the image obtaining unit 302 obtains frames of a preview image obtained by capturing the second or subsequent natural person 104 or 105. Then, in S802, the display control unit 301 displays the frames obtained in S801 on the display unit 206. Then, in S803, the feature point extraction unit 303 estimates the orientation of the natural person 104 or 105 included as a representation in the frames obtained in S801 by using these frames to extract feature points corresponding to body parts of the natural person 104 or 105. Then, in S804, based on the target feature point information stored in S705 illustrated in FIG. 7, the feature point detection unit 305 detects the feature points corresponding to the same body parts as the target feature points from among the plurality of feature points extracted in S803 (feature points of interest). Then, in S805, based on the target feature point information stored in S705 illustrated in FIG. 7, the movement amount obtaining unit 306 calculates the difference between the coordinates of the target feature points and the coordinates of the feature points of interest detected in S804.

Then, in S806, the movement amount obtaining unit 306 judges whether the value of the difference between the coordinates of the target feature points and the coordinates of the feature points of interest calculated in S805 is less than a predetermined threshold value. Specifically, the movement amount obtaining unit 306 judges whether the coordinates of the target feature points and the coordinates of the feature points of interest coincide or substantially coincide. If it is judged in S806 that the coordinates of the target feature points and the coordinates of the feature points of interest coincide or substantially coincide, the image capturing apparatus 101 terminates the flowchart illustrated in FIG. 8. If it is judged in S806 that the coordinates of the target feature points and the coordinates of the feature points of interest do not coincide or substantially coincide, the image capturing apparatus 101 executes a process of S807.

In S807, based on the difference between the coordinates of the target feature points and the coordinates of the feature points of interest calculated in S805, the movement amount obtaining unit 306 obtains the amount of movement of the image capturing apparatus 101 required for the positions of the feature points of interest to reach the positions of the target feature points. A method of obtaining the amount of movement of the image capturing apparatus 101 will be described later. After S807 is S808, in which the display control unit 301 superimposes an image indicating the amount of movement of the image capturing apparatus 101 obtained in S807 on the frames displayed in S802 and displays them on the display unit 206. A method of displaying the image indicating the amount of movement of the image capturing apparatus 101 will be described later. The photographer 102 may move the image capturing apparatus 101 based on the image indicating the amount of movement of the image capturing apparatus 101 displayed in S808. After S808, the image capturing apparatus 101 returns to the process of S801 and repeats the processes of S801 to S808 until judging in S806 that the coordinates of the target feature points and the coordinates of the feature points of interest coincide or substantially coincide.

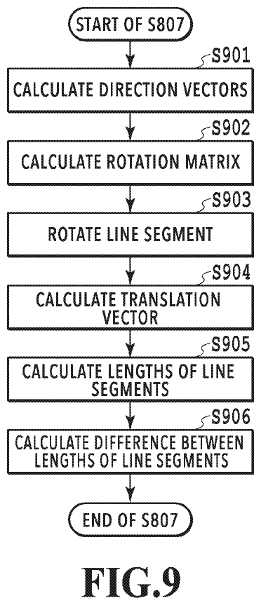

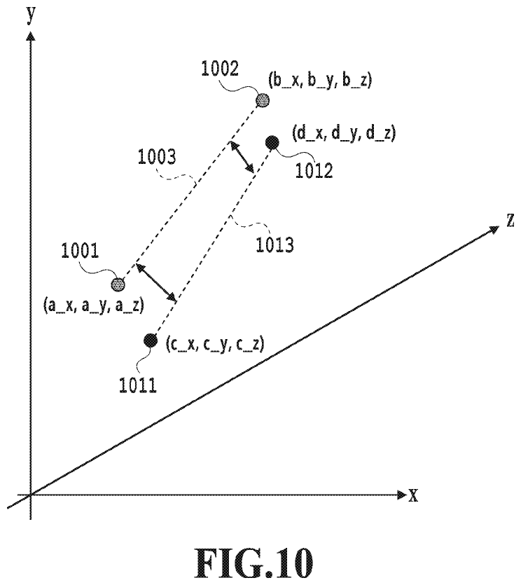

FIG. 9 is a flowchart illustrating an example of the flow of the process of obtaining the amount of movement of the image capturing apparatus 101 by the movement amount obtaining unit 306 according to the first embodiment, i.e., a detailed flow of the process of S807 illustrated in FIG. 8. Also, FIG. 10 is a diagram for describing an example of the method by which the movement amount obtaining unit 306 obtains the amount of movement of the image capturing apparatus 101 according to the first embodiment. In FIG. 10, the points illustrated with the gray dots represent an example of two target feature points 1001 and 1002. Also, in FIG. 10, the points illustrated with the black dots represent an example of a feature point of interest 1011 corresponding to the target feature point 1001 and a feature point of interest 1012 corresponding to the target feature point 1002. Also, in FIG. 10, a line segment 1003 connecting the target feature point 1001 and the target feature point 1002, and a line segment 1013 connecting the feature point of interest 1011 and the feature point of interest 1012 are illustrated. By executing the flowchart illustrated in FIG. 9, the movement amount obtaining unit 306 specifies such a position of the image capturing apparatus 101 as to align the line segment 1003 and the line segment 1013 with each other. As a result, the movement amount obtaining unit 306 obtains the amount of movement of the image capturing apparatus 101.

First, in S901, the movement amount obtaining unit 306 calculates a direction vector v1 indicating the direction of the line segment 1003 and a direction vector v2 indicating the direction of the line segment 1013. Then, in S902, the movement amount obtaining unit 306 calculates a rotation matrix R that rotates the direction vector v2 of the line segment 1013 calculated in S901 to align it with the direction vector v1 of the line segment 1003. Specifically, the rotation matrix R is a matrix indicating about which axis or axes and how much the direction vector v2 should be rotated to align the direction vector v2 with the direction vector v1. The rotation matrix R may be calculated using well-known Eulerian angles or quaternions, for example. The rotation matrix R calculated in S902 is stored in the RAM 203, and will be used in a display control process for the amount of rotational movement of the image capturing apparatus 101 by the display control unit 301 in S808 described above.

Then, in S903, the movement amount obtaining unit 306 rotates the line segment 1013 using the rotation matrix R calculated in S902. In the following description, the line segment being the line segment 1013 after being rotated using the rotation matrix R will be referred to as “rotated line segment.” Then, in S904, the movement amount obtaining unit 306 calculates a translation vector vp indicating an amount of movement and a direction of movement required to translate the rotated line segment to align it with the line segment 1003. Specifically, for example, the movement amount obtaining unit 306 calculates a vector, as the translation vector vp, which starts at the point on the rotated line segment corresponding to the feature point of interest 1011 and ends at the point on the line segment 1003 corresponding to target feature point 1001. The translation vector vp calculated in S904 is stored in the RAM 203, and will be used in a display control process for the amount of translational movement of the image capturing apparatus 101 by the display control unit 301 in S808 described above.

Then, in S905, the movement amount obtaining unit 306 calculates the lengths of the line segment 1003 and the line segment 1013. Then, in S906, the movement amount obtaining unit 306 calculates a difference D between the lengths of the line segment 1003 and the line segment 1013 calculated in S905. The difference D between the lengths of the line segment 1003 and the line segment 1013 calculated in S906 is stored in the RAM 203, and will be used in a display control process for the amount of translational movement of the image capturing apparatus 101 by the display control unit 301 in S808 described above. After S906, the movement amount obtaining unit 306 terminates the process of the flowchart illustrated in FIG. 9, i.e., the process of S807 illustrated in FIG. 8.

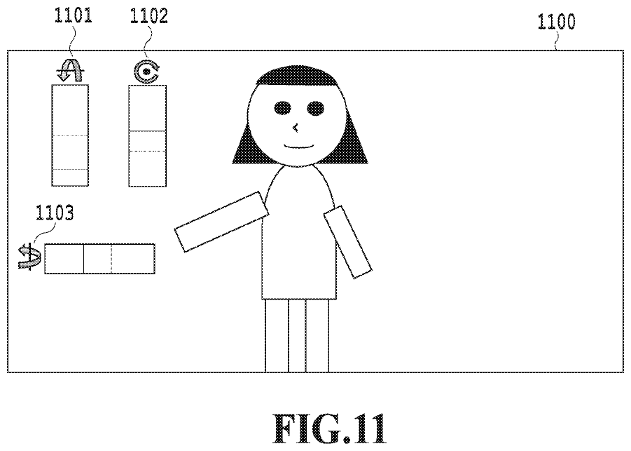

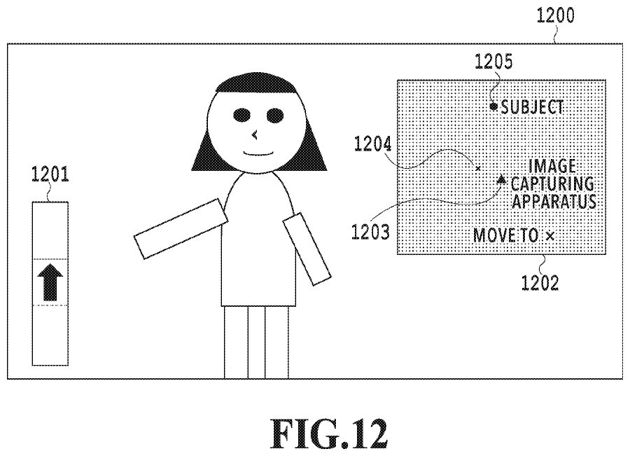

FIGS. 11 and 12 are diagrams illustrating an example of display screens 1100 and 1200 for the amount of movement of the image capturing apparatus 101 displayed on the display unit 206 according to the first embodiment. Specifically, FIG. 11 illustrates an example of the display screen 1100 for notifying the photographer 102 of the amount of rotation of the image capturing apparatus 101 about each rotation axis. The display screen 1200 illustrated in FIG. 12 will be described later. On the display screen 1100, gauges 1101 to 1103 represent in which directions and how much the image capturing apparatus 101 should be rotated. Specifically, the gauge 1101 is a gauge indicating the direction of rotation of and the amount of rotation of the image capturing apparatus 101 about an axis perpendicular to the vertical direction and the optical axis of the image capturing apparatus 101 as the rotation axis. Also, the gauge 1102 is a gauge indicating the direction of rotation of and the amount of rotation of the image capturing apparatus 101 about the optical axis of the image capturing apparatus 101 as the rotation axis. Also, the gauge 1103 is a gauge indicating the direction of rotation of and the amount of rotation of the image capturing apparatus 101 about an axis parallel to the vertical direction as the rotation axis.

Note that the line segment illustrated with the dashed line inside each gauge on the display screen 1100 illustrated in FIG. 11 indicates the current direction of the optical axis of the image capturing apparatus 101 along the corresponding axis, and the line segment illustrated with the solid line indicates the direction of a target optical axis for the image capturing apparatus 101 along the corresponding axis. The display control unit 301 determines the positions indicated by the solid line and the dashed line inside each gauge using the rotation matrix R calculated by the movement amount obtaining unit 306 in S903, and displays the display screen 1100 on the display unit 206. In a case where the photographer 102 rotates the image capturing apparatus 101, the position of the line segment illustrated with the dashed line inside each gauge on the display screen 1100 moves inside the gauge in synchronization with the rotation of the image capturing apparatus 101. By rotating the image capturing apparatus 101 while checking the state of each gauge on the display screen 1100, the photographer 102 may adjust the direction of the optical axis of the image capturing apparatus 101.

FIG. 12 illustrates an example of the display screen 1200 for notifying the photographer 102 of the amounts of movement of the image capturing apparatus 101 in the horizontal direction and the vertical direction. On the display screen 1200, a gauge 1201 and an overhead image 1202 represent in which direction and how much the image capturing apparatus 101 should be translated. Specifically, the gauge 1201 is a gauge indicating the amount of movement of the image capturing apparatus 101 in the vertical direction.

Note that the line segment illustrated with the dashed line inside the gauge 1201 indicates the current position of the image capturing apparatus 101 in the vertical direction, and the line segment illustrated with the solid line indicates a target position for the image capturing apparatus 101 in the vertical direction. Also, the arrow inside the gauge 1201 indicates a direction in which to guide the current position of the image capturing apparatus 101 in the vertical direction toward the target position. The display control unit 301 determines the positions indicated by the solid line and the dashed line inside the gauge 1201 using the translation vector vp calculated by the movement amount obtaining unit 306 in S905, and displays the display screen 1200 on the display unit 206. In a case where the photographer 102 moves the image capturing apparatus 101 in the vertical direction, the position of the line segment illustrated with the dashed line inside the gauge 1201 moves inside the gauge 1201 in synchronization with the movement of the image capturing apparatus 101. By moving the image capturing apparatus 101 in the vertical direction while checking the state of the gauge 1201 on the display screen 1200, the photographer 102 may adjust the position of the image capturing apparatus 101 in the vertical direction.

Also, the overhead image 1202 is an image indicating the direction of movement of and the amount of movement of the image capturing apparatus 101 in the horizontal direction, and is an image of the current position of the image capturing apparatus 101 and the target position for the image capturing apparatus 101 as viewed from above in the vertical direction. In the overhead image 1202, the position indicated by a black triangle 1203 represents the current position of the image capturing apparatus 101, and the position indicated by a ×mark 1204 represents the target position to which the image capturing apparatus 101 should move. Note that, in the overhead image 1202, the position indicated by a black circle 1205 represents the position of the natural person 104 or 105. In a case where the photographer 102 moves the image capturing apparatus 101 in the horizontal direction, the position of the black triangle 1203 moves within the overhead image 1202 in synchronization with the movement of the image capturing apparatus 101. By moving the image capturing apparatus 101 in the horizontal direction while checking the state of the overhead image 1202 on the display screen 1200, the photographer 102 may adjust the position of the image capturing apparatus 101 in the horizontal direction.

For example, the display control unit 301 performs display control to simultaneously display the display screen 1100 illustrated in FIG. 11 and the display screen 1200 illustrated in FIG. 12 on the display unit 206. The method by which the display control unit 301 controls the display is not limited to this, and the display screen 1100 and the display screen 1200 may be displayed in any form. For example, the display control unit 301 may firstly display only the display screen 1100 on the display unit 206, and display the display screen 1200 on the display unit 206 after the direction of the optical axis of the image capturing apparatus 101 is adjusted. Alternatively, the display control unit 301 may, for example, firstly display only the display screen 1200 on the display unit 206, and display the display screen 1100 on the display unit 206 after the position of the image capturing apparatus 101 is adjusted. Still alternatively, the display control unit 301 may, for example, alternately display the display screen 1100 and the display screen 1200 at intervals of a predetermined time.

With the image capturing apparatus 101 configured as above, in a case where each of a plurality of natural persons is a subject, the photographer 102 may easily move the image capturing apparatus 101 and capture each of the natural persons such that the captured images have the same composition, even if the natural persons differ from each other in physique. Note that in the first embodiment, a case where the capturing targets are natural persons has been described, but the capturing targets may be objects other than natural persons. That is, with the image capturing apparatus 101, in a case of capturing each of a plurality of objects, the photographer 102 may easily move the image capturing apparatus 101 and capture each of the plurality of objects such that the captured images have the same composition even if the objects differ from each other in size.

### Modification of First Embodiment

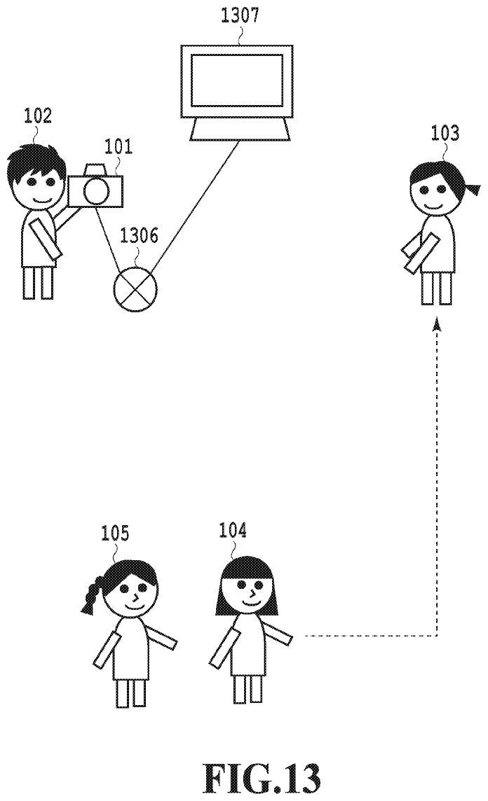

FIG. 13 is a diagram for describing an example of a use case according to a modification of the first embodiment. In the modification of the first embodiment, a display device 1307 configured with a liquid crystal display or the like is added to the configuration in the first embodiment illustrated in FIG. 1. Here, the display device 1307 is placed at such a position and in such an orientation that, in a case where each of the natural persons 103 to 105 is captured, the natural person being captured may visually check an image displayed on the display device 1307. Also, the display device 1307 is communicably connected to the image capturing apparatus 101 through a network 1306. Note that communication through the network 1306 may be wireless or wired.

In the first embodiment, an aspect in which the display screen 1200 illustrated in FIG. 12 is displayed on the display unit 206 included in the image capturing apparatus 101 to prompt the photographer 102 to move the image capturing apparatus 101 in the horizontal direction and the vertical direction has been described. Here, the relative positional relationship between the image capturing apparatus 101 and each of the natural persons 103 to 105 determines the composition of the captured image. For this reason, each of the natural persons 103 to 105 may be moved instead of the image capturing apparatus 101. Specifically, the image capturing apparatus 101 displays a display screen indicating the amount of movement of the subject natural person in the horizontal direction on the display device 1307 through the network 1306. Such a configuration may prompt the subject natural person to move themselves instead of prompting the photographer 102 to move the image capturing apparatus 101.

### Other Embodiments

In the first embodiment, an aspect in which the photographer 102 adjusts the position of the image capturing apparatus 101 and the direction of its optical axis has been described. Also, in the modification of the first embodiment, an aspect in which the subject natural person moves themselves to adjust the relative positional relationship between the image capturing apparatus 101 and the subject has been described. However, the technical scope of the present disclosure is not limited to these. For example, in a case where the image capturing apparatus 101 is installed on a moving body, such as a drone, the image capturing apparatus 101 may output information indicating an amount of rotational movement and an amount of translational movement. In this case, the output information is used for automatic control of the moving body's movement, orientation, and the like. With such a configuration, in a case of capturing each of a plurality of objects, it is possible to cause the image capturing apparatus 101 to automatically move and capture each of the plurality of objects such that the captured images have the same composition even if the objects differ from each other in size.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technology of the present disclosure, it is possible to capture each of objects in an appropriate composition.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-59913, filed Mar. 31, 2025, which is hereby incorporated by reference herein in its entirety.

What is claimed is:

1. A control apparatus comprising:
one or more memories storing one or more programs; and
one or more hardware processors, that when executing the one or more programs, cause the control apparatus to:
determine at least two first feature points as target feature points from among a plurality of first feature points extracted from a first object included in a first image obtained by first capturing;
detect second feature points corresponding to the target feature points as feature points of interest from among a plurality of second feature points extracted from a second object included in a second image obtained by second capturing;
obtain a correction amount for at least one of a position and direction of an image capturing device in third capturing of the second object based on positions of the target feature points and positions of the feature points of interest corresponding to the target feature points; and
output the correction amount.

2. The control apparatus according to claim 1, wherein the control apparatus is further caused to:
extract a plurality of feature points from an object included in an image;
generate feature point information including part information indicating parts of the object corresponding to the extracted feature points; and
detect from among the plurality of second feature points, the second feature points corresponding to the same parts as parts corresponding to the target feature points as the feature points of interest, based on the feature point information corresponding to the target feature points and the feature point information corresponding to the second feature points.

3. The control apparatus according to claim 1, wherein the control apparatus is further caused to extract a plurality of feature points based on a result of estimation of an orientation of an object included in an image.

4. The control apparatus according to claim 1, wherein the control apparatus is further caused to:
extract a plurality of feature points from an object included in an image;
generate feature point information including position information indicating positions of the extracted feature points;
obtain a first direction vector and a second direction vector based on the feature point information corresponding to the target feature points and the feature point information corresponding to the feature points of interest, the first direction vector indicating a direction of a straight line passing the target feature points that are different from each other, the second direction vector indicating a direction of a straight line passing the feature points of interest that are different from each other; and
obtain the correction amount based on the obtained first direction vector and second direction vector.

5. The control apparatus according to claim 1, wherein the control apparatus is further caused to determine the target feature points from among the plurality of first feature points based on an operation by a user.

6. The control apparatus according to claim 5, wherein the control apparatus is further caused to:
display the plurality of first feature points; and
determine the target feature points based on an operation of selecting desired ones of the first feature points from among the displayed plurality of first feature points by a user.

7. The control apparatus according to claim 1, wherein the control apparatus is further caused:
output the correction amount by displaying the correction amount on a display device.

8. A control method comprising:
determining at least two first feature points as target feature points from among a plurality of first feature points extracted from a first object included in a first image obtained by first capturing;
detecting second feature points corresponding to the target feature points as feature points of interest from among a plurality of second feature points extracted from a second object included in a second image obtained by second capturing;
obtaining a correction amount for at least one of a position and direction of an image capturing device in third capturing of the second object based on positions of the target feature points and positions of the feature points of interest corresponding to the target feature points; and
outputting the correction amount.

9. A non-transitory computer readable storage medium storing a program for causing a computer to perform a control method of a control apparatus, the control method comprising:
determining at least two first feature points as target feature points from among a plurality of first feature points extracted from a first object included in a first image obtained by first capturing;
detecting second feature points corresponding to the target feature points as feature points of interest from among a plurality of second feature points extracted from a second object included in a second image obtained by second capturing;
obtaining a correction amount for at least one of a position and direction of an image capturing device in third capturing of the second object based on positions of the target feature points and positions of the feature points of interest corresponding to the target feature points; and
outputting the correction amount.
